(19) United States
(12) Patent Application Publication
(10) Pub. No.: US 2012/0104814 A1
(43) Pub. Date: May 3, 2012

(54) Modular passenger seat for a passenger transportation vehicle

(76) Inventor: Benno Schiefer, Dusseldorf (DE)

(21) Appl. No.: 12/938,418

(22) Filed: Nov. 3, 2010

(51) Int. Cl. B60N 2/01

(52) U.S. Cl. 297/232

(57) ABSTRACT

A modular passenger seat for a passenger transportation vehicle is provided. The passenger seat is attached in a releasable fashion to a floor or to a side wall of the passenger transportation vehicle indirectly or directly by a supporting structure. In order to provide a modular passenger seat concept, the supporting structure includes a horizontal carrier to which upright frame parts for releasably attaching seat elements arranged there between are secured at a variable lateral distance from one another.

### FIELD OF INVENTION

The invention relates to a modular passenger seat for a passenger transportation vehicle, which is attached in a releasable fashion to the floor or to the side wall of the passenger transportation vehicle indirectly by means of a supporting structure or directly.

### SUMMARY OF INVENTION

The installation and removal of vehicle seats in passenger transportation vehicles is to be performed easily, and the intention is to make it possible to replace the seats quickly or change them in terms of their seating orientation (in the direction of travel or counter to the direction of travel). The distance between adjacent seats, in particular when two seats are attached one next to the other to a supporting structure, is to be simple and easy to adjust. These requirements relate to the known, so-called cantilever seats as well as to the seats which are anchored to the floor of the vehicle by means of foot structures. Both types can, for example, only be oriented in the horizontal plane by means of elongate drilled holes at their attachment points, which also entails a high degree of expenditure on installation.

A further problem of known vehicle seats is the restricted adaptability to different vehicles and vehicle widths as well as the low flexibility in the positioning of the seats in the passenger compartment. Finally, simple maintenance of the vehicle seats in the case of soiling and damage, in particular of the seat upholstery, is also a significant factor which is to be taken into account in the design and configuration of vehicle seats in passenger transportation vehicles. Hitherto, it has therefore been possible to adapt the width of seats during the construction of rail vehicles only by redesigning the entire seat and back shell, including the upholstery thereof. This represents a significant cost factor owing to the additional expenditure on design and the tooling costs for a plurality of seat components.

An object of the present invention is to provide a modular passenger seat concept in which the problems and disadvantages indicated above are avoided, in particular the flexible seat adaptation of a maintenance-friendly and installation-friendly passenger seat without redesigning the seat shell and back shell is made possible, and with which retrofitting to different requirements is quick and easily possible.

In order to achieve the object, a modular passenger seat of the type described at the beginning is proposed, whose supporting structure has a horizontal carrier to which upright frame parts for releasably attaching seat elements arranged therebetween can be secured at a variable lateral distance from one another. Although the frame parts are preferably mounted on a cantilever suspension system, the seats can, however, also be integrated in the vehicle with relatively low expenditure by means of floor supports.

To provide a particularly favorable object, the carrier is embodied as a tube or tubular profile onto which, according to a further feature of the invention, the frame parts are fitted and secured at a previously defined distance.

In order to simplify the manufacture and to minimize the costs, the frame parts can be formed from flat profiles, in particular cut-out pieces of sheet metal.

However, it is also conceivable to construct the frame parts from shaped longitudinal profiles, in particular rectangular profiles.

According to one particularly favorable feature of the invention, the seat elements which are arranged between the frame parts are formed from a plurality of individually replaceable elongate standardized upholstered elements which are arranged horizontally and in parallel with one another and which span the seat width.

In order to permit simple replaceability of worn or damaged upholstered elements and to bring about the modular character of the seat concept, according to another feature of the invention it is proposed that the upholstered elements of each seat element are identical upholstered rolls whose length is a multiple of their diameter between the frame parts.

In order to achieve sufficient stability and to permit secure attachment to the seat, according to the invention the upholstered elements which form the seat elements are provided with a metal core and attachments on both sides for mounting on the frame parts.

According to the modular concept, a prefabricated perforation pattern for attaching the upholstered elements at the desired distances and in the desired positions on the upholstered elements is preferably provided in the frame parts. This perforation pattern permits the upholstered elements to be attached in different arrangements, with the result that a very flexible seat configuration is made possible without having to change the frame parts. As a result, not only a flexible system is provided but the manufacturing costs and the storage costs can also be reduced by using the inventive concept.

Furthermore, there is provision for the frame parts to be secured to the carrier in a replaceable fashion in order to change the seat element. It is therefore possible to assemble seats with or without armrests or headrests in a modular fashion by combining corresponding frame parts with the respective upholstered parts.

It is also conceivable for identical frame parts to be respectively equipped with additional modules for headrests and armrests which are, for example, screwed onto the frame parts.

The concept with the frame parts which are releasably attached to the carrier very easily permits an adaptation of the seat widths to the conditions and allows the inclination of the seat to be changed according to the invention by rotating or adjusting the frame parts on the carrier or the carrier itself. The inclination of the seat and backrest and the shape of the seat can easily be modified, for example in the first case by rotating and re-securing the lateral frame parts, and in the second case by replacing the frame parts with frame parts with new contours and new drilled guide holes.

The invention removes the connection between the shape of the upholstery and the shape of the seat. A seat system which is independent of dimensions is produced by breaking the seat contour up into individual identical segments which can be standardized and which do not form the shape of a seat surface or backrest surface until after installation on the seat frame. This provides the advantage of the possibility of cost-effective modification of the seat width and seat height as well as of the seat contour. The thickness of the upholstery can be modified easily and cost-effectively. The installation and removal of the seat as well as the possibility of maintaining the seat by simply replacing individual upholstered rolls is advantageous. There is, furthermore, a large degree of freedom in the configuration of the color of the upholstered seats (virtually any upholstered roll can be colored or patterned separately).

### BRIEF DESCRIPTION OF THE DRAWINGS

An exemplary embodiment of the invention will be described below on the basis of the drawing, in which:

FIG. 1 shows a group of modular passenger seats in a cantilever embodiment, and

FIG. 2 shows a group of modular passenger seats with a bracket which is attached to the floor.

### DETAILED DESCRIPTION OF INVENTION

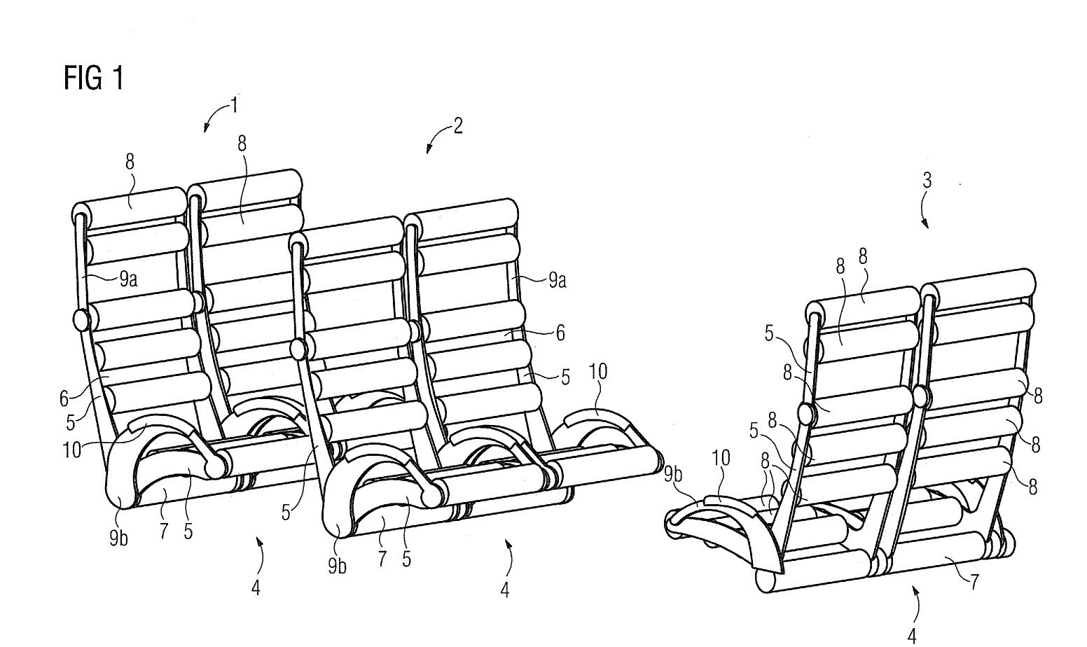

FIG. 1 illustrates a group of modular passenger seats for a total of six persons, wherein in each case two seats are combined to form a seat bench 1, 2 and 3. Each passenger seat is arranged on a carrier 4 to which upright frame parts 5 are secured at a lateral distance from one another in order to attach the seat elements 6 arranged therebetween. The frame parts 5 are installed on a cantilever supporting tube 7 via the carrier 4 and are composed of flat profiles which are each cut or burnt out from pieces of sheet metal, for example. The frame parts each form the supporting structure for the backrest and the seat, to which structure the upholstered elements 8 are attached. The upholstered elements 8 are composed of individually replaceable cylindrical elements which are preferably provided with a metal core which is encased with an elastic upholstered element. The metal core is attached on both sides to the frame parts 5, for example by means of screws, in order to attach the upholstered elements 8. A plurality of upholstered elements 8 which are attached to the frame parts 5 in parallel with one another farm the seat face and back face of the passenger seat. In order to attach the upholstered elements 8 to the frame parts 5 in a simplified way, a prefabricated perforation pattern is prepared in the frame parts 5, which makes the attachment of the upholstered elements 8 in different arrangements possible for the purpose of configuring the seat in a flexible way. Furthermore, the frame parts 5 can be extended by additional modules 9, for example by additional modules 9a for headrests or 9b for armrests by simply screwing on these additional modules 9 to the frame parts 5 of the seat frame. The additional modules 9a for headrests are supplemented with the modular upholstered elements 8 which are embodied in the same way, and the additional modules 9b of the armrests are preferably also formed from profiles, preferably from flat profiles, and provided with upholstered armrests 10.

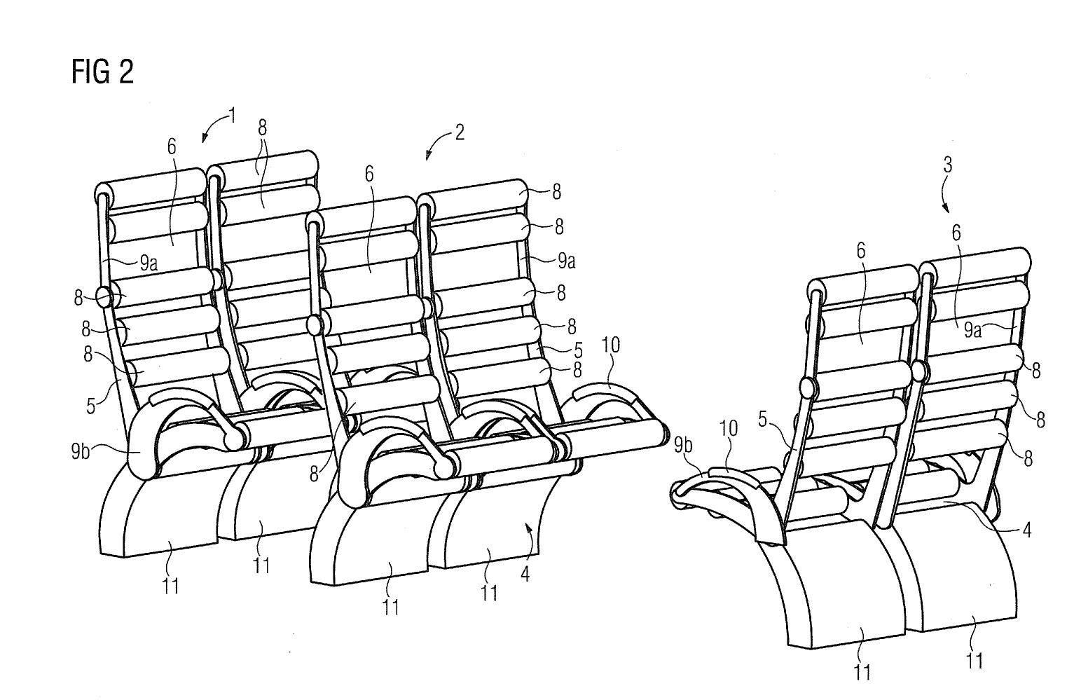

FIG. 2 illustrates a seat group which is constructed in the same way, but the seats of which are attached, in this example, to supporting brackets 11 which are secured to the floor of the vehicle. The attachment to the floor can preferably be varied, permitting the modular passenger seats to be grouped in a different way. In FIG. 2, identical parts are numbered in the same way, and the passenger seats are also formed here from individual cylindrical upholstered elements 8 which permit very flexible configuration of the seat by virtue of their modular design. Furthermore, upholstered elements 8 of different lengths can also be used, for example in order to construct passenger seats with different widths. For example, the distance between the frame parts 5 can be changed at their securing element (cantilever supporting tube 7 or supporting bracket 11) in order to insert relatively short or relatively long upholstered elements 8. The upholstered elements 8 can be replaced individually so that damaged or worn upholstered elements can very easily be replaced with new elements. The modular arrangement permits a high degree of freedom in terms of the arrangement and configuration of the coloring of the seat upholstery, and this can also be easily changed when necessary.

1.-12. (canceled)

13. A modular passenger seat for a passenger transportation vehicle, comprising:
a supporting structure, the modular passenger seat being attached in a releasable fashion to a floor or to a side wall of the passenger transportation vehicle directly or indirectly by the supporting structure;
frame elements; and
detachable seat elements,
wherein the supporting structure includes a horizontal carrier, the frame elements being secured at a variable lateral distance from one another at the horizontal carrier, and
wherein the detachable seat elements are arranged between the frame elements.

14. The modular passenger seat as claimed in claim 13, wherein the horizontal carrier is embodied as a tube or tubular profile.

15. The modular passenger seat as claimed in claim 14, wherein the frame elements are fitted onto the tube or tubular profile and secured at a previously defined distance.

16. The modular passenger seat as claimed in claim 13, wherein the frame elements are formed from flat profiles.

17. The modular passenger seat as claimed in claim 16, wherein the frame elements are cut-out pieces of sheet metal.

18. The modular passenger seat as claimed in claim 13, wherein the frame elements are formed from shaped longitudinal profiles.

19. The modular passenger seat as claimed in claim 18, wherein the frame elements include rectangular profiles.

20. The modular passenger seat as claimed in claim 12, wherein each seat element is formed from a plurality of individually replaceable elongate standardized upholstered elements which are arranged horizontally and in parallel with one another and which span the seat width.

21. The modular passenger seat as claimed in claim 20, wherein the upholstered elements of each seat element are identical upholstered rolls, and wherein a length of one upholstered roll is a multiple of a diameter of the roll.

22. The modular passenger seat as claimed in claim 20, wherein the upholstered elements forming the seat elements include a metal core and attachments on both sides for mounting onto the frame elements.

23. The modular passenger seat as claimed in claim 21, wherein the upholstered elements forming the seat elements include a metal core and attachments on both sides for mounting onto the frame elements.

24. The modular passenger seat as claimed in claim 13, wherein the frame elements comprise a prefabricated perforation pattern for attaching the upholstered elements at desired distances and in desired positions.

25. The modular passenger seat as claimed in claim 13, wherein the frame elements can be replaced in order to change the seat element.

26. The modular passenger seat as claimed in claim 13, wherein the frame parts can be equipped with additional modules for headrests and armrests.

27. The modular passenger seat as claimed in claim 13, wherein an inclination of the seat can be changed by rotating or adjusting the frame elements on the carrier or by the carrier itself.
